(19) United States
(12) Patent Application Publication
(10) Pub. No.: US 2024/0083774 A1
(43) Pub. Date: Mar. 14, 2024

(54) Biogenic Refinery

(71) Applicant: DYPER Inc., Scottsdale, AZ (US)

(72) Inventors: Mark D. Siminoff, Mountain View, CA (US); Anthony P. Patron, Mountain View, CA (US); Jeffrey R. Hallowell, Woodstock, CT (US); Sergio Radovcic, Charleston, SC (US)

(21) Appl. No.: 18/244,565

(22) Filed: Sep. 11, 2023

Related U.S. Application Data
(60) Provisional application No. 63/406,337, filed on Sep. 14, 2022.

(51) Int. Cl. C02F 1/02

(52) U.S. Cl. CPC C02F 1/02

(57) ABSTRACT

A biogenic refinery has a pyrolysis pot, an exhaust plenum, and a drag chain conveyor system having first and second drag chain conveyor portions. The first and second drag chain conveyor portions have a drying region disposed in the exhaust plenum with the second drag chain conveyor portion depositing feedstock in the pyrolysis pot. A control system includes a drive to control the drag chain conveyor system, a humidity sensor sensing moisture in the exhaust plenum, and a controller that receives a signal from the humidity sensor, compares the humidity sensor signal with the desired moisture level in the exhaust, and controls the drag chain conveyor system based upon a difference between the humidity sensor signal and the desired moisture level in the exhaust to control a rate of movement of the feedstock through the drying regions of the first and second drag chain conveyor portions.

### RELATED APPLICATION DATA

This application claims priority benefit of U.S. provisional application Ser. No. 63/406,337, filed Sep. 14, 2022, the disclosure of which is incorporated by reference herein.

### SUMMARY

The present disclosure is directed to a biogenic refinery that is specifically configured to generate biochar and similar products from pyrolysis heating processes using feedstock comprising shredded sanitary products such as diapers, sanitary wipes, and other fibrous hygienic products including such products comprising human waste.

### DESCRIPTION OF THE DRAWINGS

FIG. 1 shows a schematic diagram of a biogenic refinery with process flows through the biogenic refinery for feedstock and exhaust gas;

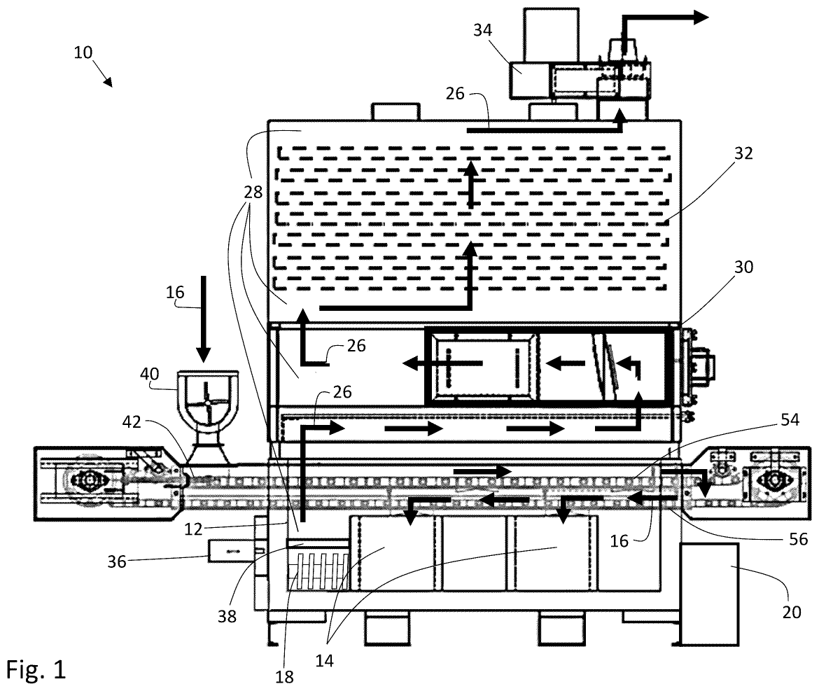

FIG. 2 shows an end view of the biogenic refinery of FIG. 1;

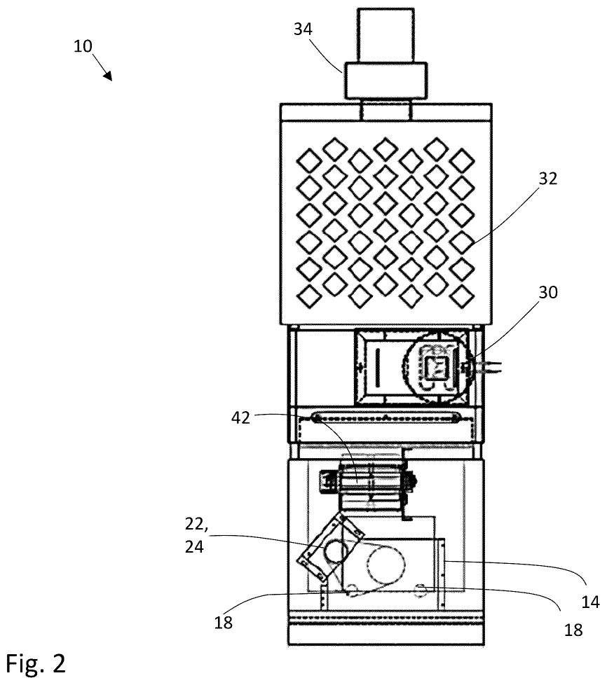

FIG. 3 a schematic diagram of upstream processing equipment for shredding the feedstock and introducing the feedstock into the biogenic refinery of FIG. 1 and including portions of a control system of the biogenic refinery;

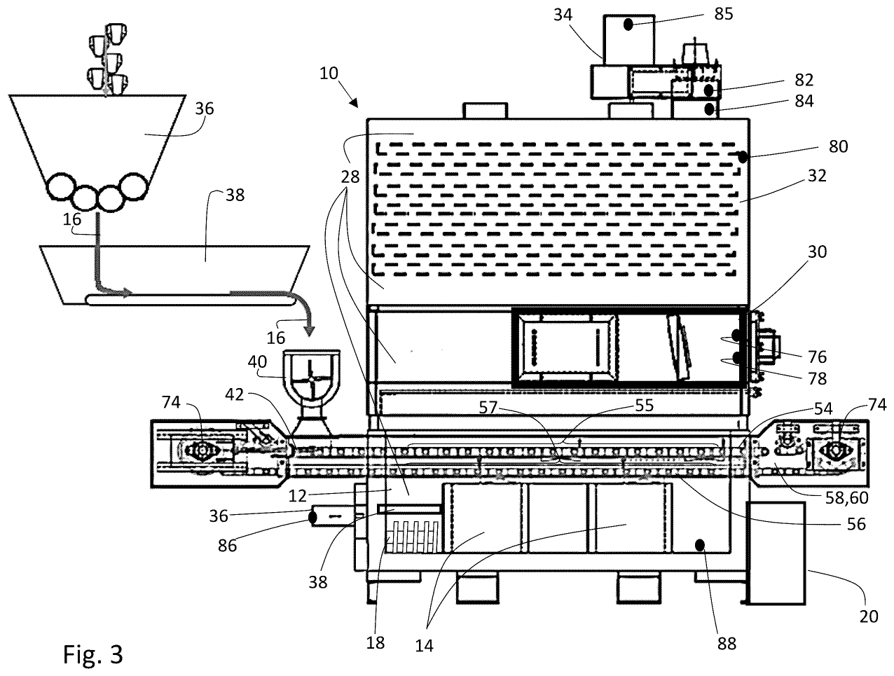

FIG. 4 shows a top plan view of a portion of drag chain conveyor system for conveying feedstock to pyrolysis pots of the biogenic refinery; and

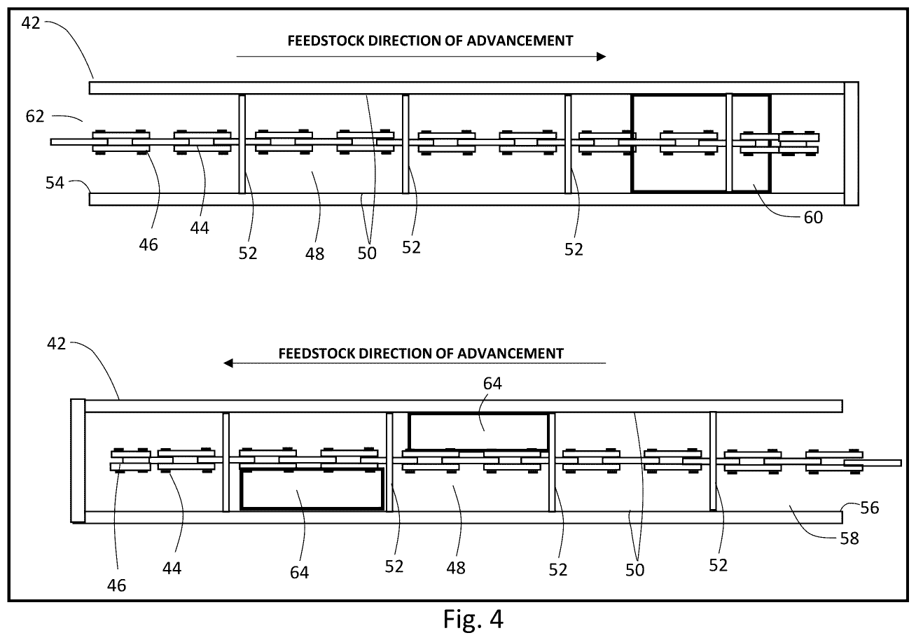

FIG. 5 is a schematic diagram showing a control system associated with the biogenic refinery of FIG. 1.

### DETAILED DESCRIPTION

The biogenic refinery 10 includes an enclosed combustion chamber 12 with at least one pyrolysis pot 14 into which feedstock 16 is directed and heated to form biochar and other substances as a result of pyrolysis heating. The introduction of the feedstock 16 into the pyrolysis pots 14, the heating of the feedstock in the pyrolysis pots to form biochar and pyrolysized substances, and their removal from the pyrolysis pots 14 and the combustion chamber 12 may be continuous or may be a batch-type operation. While the drawings show two pyrolysis pots in the combustion chamber, one, two or more than two pyrolysis pots may be arranged in the combustion chamber.

Inside the combustion chamber, an auger conveyor system 18 may be provided to remove biochar and pyrolysized substances from the pyrolysis pots 14 and combustion chamber 12 to a collection box 20 adjacent to the combustion chamber thereby allowing the materials to be removed from the biogenic refinery 10. The auger conveyor system 18 may be driven by a motor 22 having an associated drive 24. The auger conveyor system 18 may pass through the walls of the combustion chamber 12 into the pyrolysis pots 14 and terminate at collection box 20. To maintain proper oxygen levels for the pyrolysis process, the combustion chamber 12 may have a system of seals adjacent to the locations where the auger conveyor system 18 passes through the walls of the combustion chamber. The combustion chamber 12 may also be operated at lower pressure than the collection box 20 so exhaust gases are confined to the combustion chamber.

The combustion chamber 12 and/or pyrolysis pots 14 may include an agitator (not shown) that enables the pyrolysized feedstock to move from the pyrolysis pots 14 to the extraction augers of the auger conveyor system 18. The agitator may be operatively connected to the extraction augers so that the drive and motor for the extraction augers also drives the agitator.

Exhaust gases 26 from the pyrolysis process may be exhausted from the combustion chamber 12 through an exhaust plenum 28. The exhaust plenum 28 may extend through the biogenic refinery and direct exhaust gases from the pyrolysis pots 14 through a pollution control device 30 and a heat exchanger 32 prior to being vented to atmosphere. An inducer fan 34 may be provided on the discharge of the exhaust plenum 28 to draw the exhaust gases 26 into the exhaust plenum and through the components of the exhaust system, including the pollution control device and the heat exchanger 32. In one aspect, the inducer fan 34 may be arranged to draw combustion air into the combustion chamber 12 and into the pyrolysis pots 14 inside the combustion chamber. Alternatively, another blower fan 36 may be provided adjacent the combustion chamber 12 to supply combustion air to the pyrolysis pots 14 in the combustion chamber. Combustion air may be delivered to the pyrolysis pots from the blower fan 36 with an air tube 38 that communicates with the combustion chamber.

The pollution control device 30 may be provided in the exhaust plenum. The pollution control device 30 may include filters and a catalytic converter. The catalytic converter may burn uncombusted exhaust products to reduce NOx emissions in the exhaust gases 26. The catalytic converter may be configured to generate additional thermal energy which can be passed to the heat exchanger 32 for use as an energy source in operating secondary or auxiliary systems.

The feed stock 16 may be conditioned prior to delivery to the biogenic refinery 10. In one aspect, the feedstock 16 may be directed to a shredder 36 for bulk shredding of the feedstock. For instance, a WEIMA ZMK 40 shredder has been proven to be useful for shredding sanitary products, including fibrous hygienic products. The feedstock 16 may then pass through a hopper 38 which may meter the feedstock in appropriate amounts to be introduced to the biogenic refinery 10. For instance, a Fisher Poly-Caster, hopper with integrated drag chain has been proven to be useful for uniform and even dispensing and delivering of shredded sanitary products, including fibrous hygienic products, to the biogenic refinery 10. The outlet of the feedstock hopper 38 may be aligned with an airlock 40 associated with the entrance to the biogenic refinery. Feedstock 16 from the feedstock hopper 38 may pass through the airlock 40 into the biogenic refinery 10 onto a conveyor system 42 which is configured to draw the feedstock into the biogenic refinery and towards the pyrolysis pots 14.

For conveying feedstock materials including sanitary products, including diapers, wipes, and fibrous hygienic products, through the biogenic refinery, a drag chain conveyor system 42 has proven effective. In addition, the provision of a double pass of the feedstock 16 through the conveyor system 42 has proven effective to increase the residence time of the feedstock in the biogenic refinery 10 for controlled drying of the feedstock before introduction to the pyrolysis pots 14. Given the nature of the feedstock and the need for efficient pyrolysis, it is necessary to control moisture content of the feedstock 16.

The drag chain conveyor system 42 includes a drag chain 44 with pivoting linkages 46 that allow the drag chain to move as an endless loop through the biogenic refinery 10. On a supply run of the endless loop of the drag chain conveyor system, the drag chain conveyor system 42 may include a horizontal support 48 with side walls 50 with the drag chain 44 is centrally located between the sidewalls 50. On a return run of the endless loop of the drag chain conveyor system, the horizontal support with side wall is not necessary. The drag chain conveyor system 42 may include a plurality of pusher elements 52 connected to and extending transversely from the drag chain 44. On the supply run, the pusher element 52 may slide along the horizontal support 48 confined between the side walls 50 as the drag chain 44 advances the pusher element from one end of the drag chain conveyor system to an opposite end of the drag chain conveyor system. Feedstock 16 introduced to the drag chain conveyor system 42 may move along the horizontal support 48 while being constrained by the side walls 50 as the pusher element 52 moves feedstock 16 from one end of the conveyor system to the opposite end of the conveyor system.

In one aspect, the drag chain conveyor system 42 has a first drag chain conveyor portion 54 and a second drag chain conveyor portion 56 so as to provide the feedstock with a double pass of drying of the feedstock prior to introduction to the pyrolysis pots. Thus, in general sense, the biogenic refinery 10 is configured so that heat from operation of the biogenic refinery may be used to dry the (wet) feedstock 16 that is used to fuel the biogenic refinery. The first drag chain conveyor portion 54 is adapted and configured to move feedstock in a direction of advancement along a length of the first drag chain conveyor portion. The first drag chain conveyor portion 54 has a drying region 55 along its length. The drying region 55 of the first drag chain conveyor portion 54 is disposed in the exhaust plenum 28 of the biogenic refinery. For instance, as shown in the drawings, the first drag chain conveyor portion 54 moves the feedstock from the air lock 40 on the left of the biogenic refinery 10 and into a lower part of the exhaust plenum 28 that extends into the combustion chamber 12 where the first drag chain conveyor portion passes over the tops of the pyrolysis pots 14 to provide an initial heating of the feedstock 16.

The first drag chain conveyor portion 54 then passes the feedstock 16 to a second drag chain conveyor portion 56. The second drag chain conveyor portion 56 is adapted and configured to move the feedstock in a direction of advancement along a length of the second drag chain conveyor portion. The second drag chain conveyor portion 56 has a drying region 57 along its length. As shown in the drawings, the second drag chain conveyor portion 56 moves the feedstock from an inlet 58 of the second drag chain conveyor portion on the right of the biogenic refinery, which is in register with a discharge 60 of the first drag chain conveyor portion, and into a lower part of the exhaust plenum 28 that extends into the combustion chamber 12 below the first drag chain conveyor portion 54 where the second drag chain conveyor portion 56 passes over the tops of the pyrolysis pots 14 to provide an second heating of the feedstock.

In one aspect, the first drag chain conveyor portion 54 comprises a first separate conveyor having an inlet 62 and outlet 60 with the drying region 55 extending between the inlet and outlet of the first conveyor, and the second drag chain conveyor portion 56 comprises a second separate conveyor having an inlet 58 and an outlet 64 with the drying region 57 extending between the inlet and the outlet of the second conveyor. In such an arrangement, the outlet of the first conveyor 60 is adapted and configured to deposit feedstock at the inlet of the second conveyor 58; and the outlet 64 of the second drag chain is adapted and configured to deposit the feedstock in the pyrolysis pot(s) 14. As an example, the first drag chain conveyor portion 54 may be arranged so that the pusher element 52 of the chain link structure empties the feedstock 16 at the outlet 60 of the first drag chain conveyor portion onto the inlet 58 of the second drag chain conveyor portion 56 as the pusher element transitions from the supply run to the return run. As another example, the first drag chain conveyor portion 54 may have its outlet 60 configured with an opening in the horizontal support 48. As the pusher element 52 moves toward the outlet 60 and over the opening, the pusher element pushes the feedstock so the feedstock falls through the opening onto the inlet 58 of the second drag chain conveyor portion 56. The opening 60 in the horizontal support 48 may be arranged prior to the point at which the pusher element 52 transitions from the supply run to the return run. While the drawings show a separate conveyor comprising the first drag chain conveyor portion and a separate conveyor comprising the second drag chain conveyor portion, the first drag chain conveyor portion and the second drag chain conveyor portion may comprise a single conveyor with the first and second drag chain portions. Also, depending upon the conveyor system configuration, the direction of advancement of the second drag chain conveyor portion may be opposite of the direction of advancement of the first drag chain conveyor portion, or the two drag chain conveyor portions may advance the feedstock in the same direction. And, depending upon the conveyor system configuration, the first drag chain conveyor portion 54 may be arranged above the second drag chain conveyor portion 56, for instance, as shown in the drawings, or the two drag chain conveyor portions may be in the same plane. Further, drag chain conveyor portions (and as the case may be, conveyors) and associated drying regions for each drag chain conveyor portion may be provided.

The second drag chain conveyor portion 56 may be adapted and configured to deposit the feedstock 16 in the at least one pyrolysis pot 14. In a configuration of the biogenic refinery 10 comprising at least two pyrolysis pots 14, the second drag chain conveyor portion 56 may be adapted and configured to alternatingly deposit the feedstock 16 in the at least two pyrolysis pots 14. In one aspect, a section of the second drag chain conveyor portion 56 may be formed with an opening 64 in the horizontal support 48 on one side of the chain link structure 44, and an opening 64 in the horizontal support 48 on the other side of the chain link structure 44. One of the openings 64 may communicate with one of the pyrolysis pots 14, while other of the openings 64 communicates with the other of the pyrolysis pots 14. The openings 64 may be staggered in the direction of advancement of the second drag chain conveyor portion 56 across the horizontal surface 48 of the second drag chain conveyor portion in the exhaust plenum 28. Accordingly, as the pusher element 52 moves across the horizontal support 48, the feedstock 16 on one side of the chain link structure may flow through one opening into one of the pyrolysis pots and feedstock on the other side of the chain link structure may flow through the other opening into the other of the pyrolysis pots. Further openings 64 with additional staggered relationships on the horizontal support 48 of the second drag chain conveyor portion may be provided depending upon the number of pyrolysis pots 14 provided in the biogenic refinery, a desired drying rate, a desired feed rate and the size of the second drag chain conveyor portion.

The biogenic refinery 10 may include a control system 70 for controlling aspects of operating of the biogenic refinery. In a general sense, the control system 70 may include a controller 72 with a process and memory to allow execution of program instructions via software, hardware, combinatorial logic, Application Specific Integrated Circuits (ASICs), Field-Programmable Gate Arrays (FPGAs) or other hardware, firmware or combinations thereof. Embodiments may be implemented by a processor executing, or controlled by, instructions stored in a memory. The memory may be random access memory (RAM), read-only memory (ROM), flash memory or any other memory, or combination thereof, suitable for storing control software or other instructions and data. Systems may be embodied using a variety of data structures. The control system may include a human machine interface (HMI) for operator use.

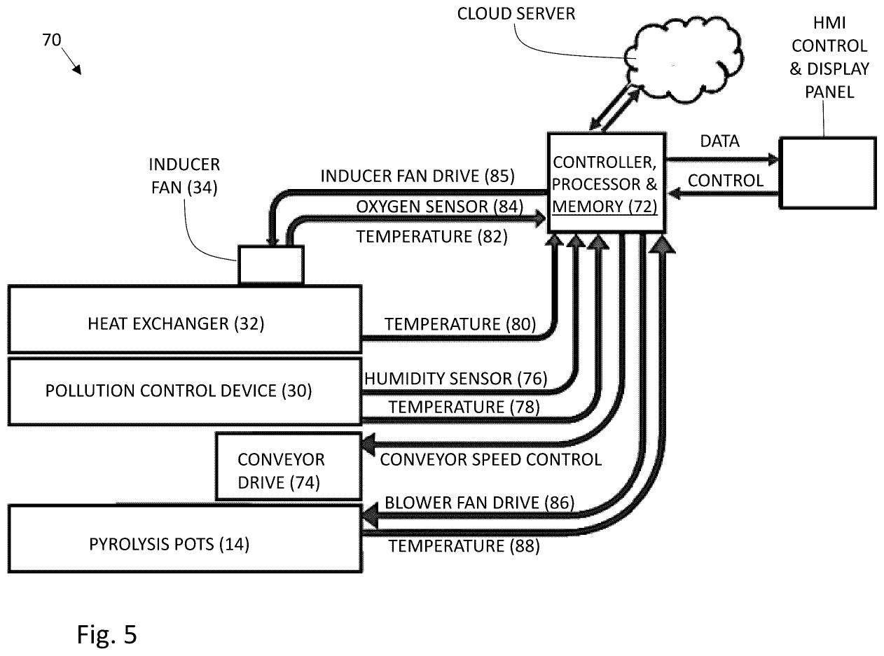

In one aspect, a portion of the control system 70 may be configured as a closed-loop electro-mechanical system to control the rate of drying of the feedstock in the drying regions 55,57 of the respective first and second drag chain conveyor portions 54,56 to optimize the moisture content of the feedstock as well as optimize the operating parameters within the refinery to improve biochar production volumes and to reduce or eliminate harmful exhaust emissions. Making reference to FIG. 5, the control system 70 may include a drive 74 adapted and configured to control the drag chain conveyor system 42, and a humidity sensor 76 adapted and configured to sense moisture in the exhaust 26 and generate a signal corresponding thereto. The humidity sensor 76 may be arranged adjacent to the pollution control device 30 in the exhaust plenum 28. In one aspect, control system 70 is adapted and configured to: (i) receive the signal from the humidity sensor 76; (ii) store a plurality of data structures in the memory of the controller 72, the plurality of data structures comprising a desired moisture level in the exhaust 26; (iii) compare the humidity sensor signal with the desired moisture level in the exhaust 26; and (iv) generate a signal for controlling the drive 74 of the drag chain conveyor system 42 based upon a difference between the humidity sensor signal and the desired moisture level in the exhaust to control a rate of movement of the feedstock 16 through at least one of the drying region 55 of the first drag chain conveyor portion 54 and the drying region 57 of the second conveyor portion 56 of the drag chain conveyor system. To provide further control of the drag chain conveyor system 42, the control 70 may also be adapted and configured to generate a signal for controlling the drive 74 of the drag chain conveyor system 42 based upon the difference between the humidity sensor signal and the desired moisture level in the exhaust to control a rate of introduction of the feedstock 16 into the at least one pyrolysis pot 14.

To provide further control of the drag chain conveyor system 42, the control system 70 may further comprise a temperature sensor 78 adapted and configured to sense temperature in the exhaust 26 at the pollution control device 30 and generate a signal corresponding thereto. The control system 70 may then be adapted and configured to: (i) receive the signal from the pollution control device temperature sensor 78; (ii) store a plurality of data structures in the memory of the controller 72, the plurality of data structures comprising a desired temperature level of the exhaust 26 at the pollution control device 30; (iii) compare the pollution control device temperature sensor signal with the desired temperature level of the exhaust 26 at the pollution control device 30; and (iv) generate a signal for controlling the drive 74 of the drag chain conveyor system 42 based upon a difference between the pollution control device temperature sensor signal and the desired temperature level of the exhaust 26 at the pollution control device 30.

To provide further control of the drag chain conveyor system 42, the control system 70 may include a temperature sensor 80 adapted and configured to sense temperature in the exhaust 26 at the heat exchanger 32 downstream of the pollution control device 30 and generate a signal corresponding thereto. The control system 70 may then be adapted and configured to: (i) receive the signal from the heat exchanger temperature sensor 80; (ii) store a plurality of data structures in the memory of the controller 72, the plurality of data structures comprising a desired temperature level of the exhaust 26 at the heat exchanger 32; (iii) compare the heat exchanger temperature sensor signal with the desired temperature level of the exhaust 26 at the heat exchanger 32; and (iv) generate a signal for controlling the drive 74 of the drag chain conveyor system 42 based upon a difference between the heat exchanger temperature sensor signal and the desired temperature level of the exhaust 26 at the heat exchanger 32.

To provide further control of the drag chain conveyor system 42, the control system 70 may include a temperature sensor 82 adapted and configured to sense temperature in the exhaust 26 at the inducer fan 34 downstream of the heat exchanger 32, and generate a signal corresponding thereto. The control system 70 may then be adapted and configured to: (i) receive the signal from the inducer fan temperature sensor 82; (ii) store a plurality of data structures in the memory of the controller 72, the plurality of data structures comprising a desired temperature level of the exhaust 26 at the inducer fan 34; (iii) compare the inducer fan temperature sensor signal with the desired temperature level of the exhaust 26 at the inducer fan 34; and (iv) generate a signal for controlling the drive 74 of the drag chain conveyor system 42 based upon a difference between the inducer fan temperature sensor signal and the desired temperature level of the exhaust 26 at the inducer fan 34.

To provide further control of the drag chain conveyor system 42, the control system 70 may include an oxygen sensor 84 adapted and configured to sense an amount of oxygen in the exhaust 26 and generate a signal corresponding thereto. The control system 70 may then is adapted and configure to: (i) receive the signal from the oxygen sensor 84; (ii) store a plurality of data structures in the memory of the controller 72, the plurality of data structures comprising a desired oxygen level of the exhaust 26; (iii) compare the oxygen sensor signal with the desired oxygen level of the exhaust 26; and (iv) generate a signal for controlling the drive 74 of the drag chain conveyor system 42 based upon a difference between the oxygen sensor signal and the desired oxygen level of the exhaust.

To provide further control of the biogenic refinery 10, the control system 70 may also be adapted and configure to: (i) receive the signal from the oxygen sensor 84; (ii) store a plurality of data structures in the memory of the controller 72, the plurality of data structures comprising a desired oxygen level of the exhaust 26 at the inducer fan 34; (iii) compare the oxygen sensor signal with the desired oxygen level of the exhaust 26; and (iv) generate a signal for controlling a drive 85 of the inducer fan 34 based upon a difference between the oxygen sensor signal and the desired oxygen level of the exhaust 26. The control system may also be adapted and configure to: (w) receive the signal from the oxygen sensor 84; (x) store a plurality of data structures in the memory of the controller, the plurality of data structures comprising a desired oxygen level of the exhaust at the inducer fan 34; (y) compare the oxygen sensor signal with the desired oxygen level of the exhaust 26 at the inducer fan 34; and (z) generate a signal for controlling the drive 74 of the drag chain conveyor system 42 based upon the difference between the oxygen sensor signal and the desired oxygen level of the exhaust 26 at the inducer fan 34 to control a rate of introduction of the feedstock 16 into the at least one pyrolysis pot 14.

To provide further control of the biogenic refinery 10, the control system 70 may generate control signals to control the drive 24 of the auger conveyor system 18. In one aspect, the controller 72 may generate the signals for the drive 24 of the auger conveyor system 18 based at least in part upon the signal(s) for controlling the drive 74 of the drag chain conveyor system 42 and the rate of movement of the feedstock 16 through at least one of the drying region 55 of the first drag chain conveyor portion 54 and the drying region 57 of the second drag chain conveyor portion 56 of the drag chain conveyor system 42. In another aspect, the controller 72 may generate the signals for the drive 24 of the auger conveying system 18 based at least in part upon the signal(s) for controlling the drive 74 of the drag chain conveyor system 42 and the rate of introduction of the feedstock 16 into the pyrolysis pot(s) 14.

To provide further control of the biogenic refinery 10, the control system 70 may generate control signals to control a drive 86 of the blower motor 36 for supplying combustion air to the combustion chamber 12 and the pyrolysis pot(s) 14. In one aspect, the controller 72 may generate the signals for the drive 86 of the blower motor 36 based at least in part upon the signal(s) for controlling the inducer fan 34. In another aspect, the controller 72 may generate the signals for the drive 86 of the blower motor 36 based at least in part upon the signal(s) for controlling the drive 24 of the motor 22 of the auger conveyor system 18. In another aspect, the controller 72 may generate the signals for the drive 86 of the blower motor 36 based at least in part upon the signal from a temperature sensor 88 adapted and configured to sense the temperature in the combustion chamber 12 and/or a pyrolysis pot(s) 14. In another aspect, the controller 72 may generate the signals for the drive 86 of the blower motor 36 based at least in part upon the signal(s) for controlling the drive 74 of the drag chain conveyor system 42 and the rate of movement of the feedstock 16 through at least one of the drying region 55 of the first drag chain conveyor portion 54 and the drying region 57 of the second drag chain conveyor portion 56 of the drag chain conveyor system. In another aspect, the controller 70 may generate the signals for the drive 86 of the blower motor 36 based at least in part upon the signal(s) for controlling the drive 74 of the drag chain conveyor system 42 and the rate of introduction of the feedstock 26 into the pyrolysis pot(s) 14.

In another aspect of the control system 70, for instance, when the drag chain conveyor system 42 comprises a first separate conveyor 54 and a second separate conveyor 56, the control system 70 may include a drive 74 for each conveyor. The control system 70 may then be configured to generate any of the aforementioned control signals for the drag chain conveyor system 42 for any one or both of the drives 74 of the respective first and second separate conveyors.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A biogenic refinery comprising:
at least one pyrolysis pot adapted and configured to heat feedstock directed into the biogenic refinery;
an exhaust plenum into which exhaust from the at least one pyrolysis pot is directed as the exhaust flows to exit the biogenic refinery;
an inducer fan adapted and configured to draw the exhaust in the exhaust plenum and direct the exhaust to exit the biogenic refinery;
an auger adapted and configured to remove processed feedstock from at least one pyrolysis pot;
a drag chain conveyor system having a first drag chain conveyor portion and a second drag chain conveyor portion, the first drag chain conveyor portion being adapted and configured to move feedstock in a direction of advancement along a length of the first drag chain conveyor portion, the first drag chain conveyor portion having a drying region along its length, the drying region of the first drag chain conveyor portion being disposed in the exhaust plenum of the biogenic refinery, the second drag chain conveyor portion being adapted and configured to move the feedstock in a direction of advancement along a length of the second drag chain conveyor, the second drag chain conveyor portion having a drying region along its length, the drying region of the second drag chain conveyor portion being disposed in the exhaust plenum of the biogenic refinery, the second drag chain conveyor portion being adapted and configured to deposit the feedstock in the at least one pyrolysis pot;
a control system including:
a drive adapted and configured to control the drag chain conveyor system;
a humidity sensor adapted and configured to sense moisture in the exhaust and generate a signal corresponding thereto; and
a controller with a processor and a memory;
wherein the control system is adapted and configured to: (i) receive the signal from the humidity sensor; (ii) store a plurality of data structures in the memory of the controller, the plurality of data structures comprising a desired moisture level in the exhaust; (iii) compare the humidity sensor signal with the desired moisture level in the exhaust; and (iv) generate a signal for controlling the drive of the drag chain conveyor system based upon a difference between the humidity sensor signal and the desired moisture level in the exhaust to control a rate of movement of the feedstock through at least one of the drying region of the first drag chain conveyor portion and the drying region of the second drag chain conveyor portion of the drag chain conveyor system.

2. The biogenic refinery of claim 1 wherein the direction of advancement of the second drag chain conveyor portion is opposite of the direction of advancement of the first drag chain conveyor portion.

3. The biogenic refinery of claim 1 further comprising at least two pyrolysis pots, the second drag chain conveyor portion being adapted and configured to alternatingly deposit feedstock in the at least two pyrolysis pots.

4. The biogenic refinery of claim 1 wherein the exhaust plenum extends to a pollution control device adapted and configured to process unburned material in the exhaust, the humidity sensor is arranged adjacent to the pollution control device.

5. The biogenic refinery of claim 4 wherein:
the control system further comprises a first temperature sensor adapted and configured to sense temperature in the exhaust at the pollution control device and generate a signal corresponding thereto; and
the control system is adapted and configured to: (v) receive the signal from the first temperature sensor; (vi) store a plurality of data structures in the memory of the controller, the plurality of data structures comprising a desired temperature level of the exhaust at the pollution control device; (vii) compare the first temperature sensor signal with the desired temperature level of the exhaust at the pollution control device; and (viii) generate a signal for controlling the drive of the drag chain conveyor system based upon a difference between the first temperature sensor signal and the desired temperature level of the exhaust at the pollution control device.

6. The biogenic refinery of claim 5 wherein the exhaust plenum passes to a heat exchanger after the pollution control device.

7. The biogenic refinery of claim 6 wherein:
the control system further comprises a second temperature sensor adapted and configured to sense temperature in the exhaust at the heat exchanger and generate a signal corresponding thereto; and
the control system is adapted and configured to: (ix) receive the signal from the second temperature sensor; (x) store a plurality of data structures in the memory of the controller, the plurality of data structures comprising a desired temperature level of the exhaust at the heat exchanger; (xi) compare the second temperature sensor signal with the desired temperature level of the exhaust at the heat exchanger; and (xii) generate a signal for controlling the drive of the drag chain conveyor system based upon a difference between the second temperature sensor signal and the desired temperature level of the exhaust at the heat exchanger.

8. The biogenic refinery of claim 7 wherein the exhaust plenum terminates at an inlet of the inducer fan after the heat exchanger.

9. The biogenic refinery of claim 8 wherein:
the control system further comprises a third temperature sensor adapted and configured to sense temperature in the exhaust at the inducer fan and generate a signal corresponding thereto; and
the control system is adapted and configured to: (xiii) receive the signal from the third temperature sensor; (xiv) store a plurality of data structures in the memory of the controller, the plurality of data structures comprising a desired temperature level of the exhaust at the inducer fan; (xv) compare the third temperature sensor signal with the desired temperature level of the exhaust at the inducer fan; and (xvi) generate a signal for controlling the drive of the drag chain conveyor system based upon a difference between the third temperature sensor signal and the desired temperature level of the exhaust at the inducer fan.

10. The biogenic refinery of claim 1 wherein:
the control system further comprises an oxygen sensor adapted and configured to sense an amount of oxygen in the exhaust and generate a signal corresponding thereto.

11. The biogenic refinery of claim 10 wherein:
the control system is adapted and configure to: (v) receive the signal from the oxygen sensor; (vi) store a plurality of data structures in the memory of the controller, the plurality of data structures comprising a desired oxygen level of the exhaust; (vii) compare the oxygen sensor signal with the desired oxygen level of the exhaust; and (viii) generate a signal for controlling the drive of the drag chain conveyor system based upon a difference between the oxygen sensor signal and the desired oxygen level of the exhaust.

12. The biogenic refinery of claim 10 wherein:
the control system is adapted and configure to: (v) receive the signal from the oxygen sensor; (vi) store a plurality of data structures in the memory of the controller, the plurality of data structures comprising a desired oxygen level of the exhaust at the inducer fan; (vii) compare the oxygen sensor signal with the desired oxygen level of the exhaust; and (viii) generate a signal for controlling the inducer fan based upon a difference between the oxygen sensor signal and the desired oxygen level of the exhaust.

13. The biogenic refinery of claim 10 wherein:
the control system is adapted and configure to: (v) receive the signal from the oxygen sensor; (vi) store a plurality of data structures in the memory of the controller, the plurality of data structures comprising a desired oxygen level of the exhaust at the inducer fan; (vii) compare the oxygen sensor signal with the desired oxygen level of the exhaust at the inducer fan; and (viii) generate a signal for controlling the drive of the drag chain conveyor system based upon a difference between the oxygen sensor signal and the desired oxygen level of the exhaust at the inducer fan to control a rate of introduction of the feedstock into the at least one pyrolysis pot.

14. The biogenic refinery of claim 1 wherein:
the control system includes a drive adapted and configured to control the auger based at least in part upon the signal for controlling the drive of the drag chain conveyor system and the rate of movement of the feedstock through at least one of the drying region of the first drag chain conveyor portion and the drying region of the second drag chain conveyor portion of the drag chain conveyor system.

15. The biogenic refinery of claim 1 wherein:
the control system includes a drive adapted and configured to control the auger based at least in part upon the signal for controlling the drive of the drag chain conveyor system and a rate of introduction of the feedstock into the at least one pyrolysis pot.

16. The biogenic refinery of claim 1 wherein:
the first drag chain conveyor portion comprises a first conveyor having an inlet and an outlet with the drying region extending between the inlet and outlet of the first conveyor;
the second drag chain conveyor portion comprises a second conveyor having an inlet and an outlet with the drying region extending between the inlet and the outlet of the second conveyor;
the outlet of the first conveyor is adapted and configured to deposit feedstock at the inlet of the second conveyor; and
the outlet of the second drag chain is adapted and configured to deposit the feedstock in the at least one pyrolysis pot.

17. The biogenic refinery of claim 16 wherein the drive of the drag chain conveyor system comprises a first drive adapted and configured to control the first conveyor and a second drive adapted and configured to control the second drag chain conveyor.

18. The biogenic refinery of claim 1 wherein the control system is adapted and configured to: (v) generate a signal for controlling the drive of the drag chain conveyor system based upon the difference between the humidity sensor signal and the desired moisture level in the exhaust to control a rate of introduction of the feedstock into the at least one pyrolysis pot.

19. The biogenic refinery of claim 1 wherein the drag chain conveyor system is configured to convey feedstock comprising sanitary products with human waste.

20. A method of heating feedstock in a biogenic refinery, wherein the biogenic refinery comprises at least one pyrolysis pot adapted and configured heat the feedstock directed into the biogenic refinery and an exhaust plenum into which exhaust from the at least one pyrolysis pot is directed as the exhaust flows to exit the biogenic refinery, the method comprising:
introducing the feedstock into the biogenic refinery via a drag chain conveyor system;
with the drag chain conveyor system, moving the feedstock on a first drag chain conveyor portion of the drag chain conveyor system and then moving the feedstock on a second drag chain conveyor portion of the drag chain conveyor system, wherein in moving the feedstock on the first drag chain conveyor portion, the feedstock is moved in a direction of advancement along a length of the first drag chain conveyor portion to a drying region along the length of the first drag chain conveyor portion, the drying region of the first drag chain conveyor portion being disposed in the exhaust plenum of the biogenic refinery, and wherein in moving the feed stock on the second drag chain conveyor portion, the feedstock is moved in a direction of advancement along a length of the second drag chain conveyor to a drying region along the length of the second drag chain conveyor portion, the drying region of the second drag chain conveyor portion being disposed in the exhaust plenum of the biogenic refinery;
with the second drag chain conveyor portion, moving the feedstock into the at least one pyrolysis pot; and
with a control system having a controller with a processor and a memory: (i) generating a signal from a humidity sensor representative of a moisture in the exhaust and transmitting the humidity sensor signal to the controller; (ii) in the memory of the controller, storing a plurality of data structures that comprising a desired moisture level in the exhaust; (iii) comparing the humidity sensor signal with the desired moisture level in the exhaust; and (iv) generating a signal for controlling a drive of the drag chain conveyor system based upon a difference between the humidity sensor signal and the desired moisture level in the exhaust to control a rate of movement of the feedstock through at least one of the drying region of the first drag chain conveyor portion and the drying region of the second drag chain conveyor portion.

21. The method of claim 20 wherein the step of moving the feedstock in the direction of advancement of the second drag chain conveyor portion includes moving the feedstock in the direction of advancement of the second drag chain conveyor portion that is opposite of the direction of advancement of the first drag chain conveyor portion.

22. The method of claim 20 further comprising:
providing the biogenic refinery with at least two pyrolysis pots; and
the step of moving the feedstock into the at least one pyrolysis pot includes configuring the second drag chain conveyor portion to alternatingly deposit feedstock in the at least two pyrolysis pots.

23. The method of claim 20 further comprising arranging the humidity sensor adjacent to a pollution control device that is configured to process unburned material in the exhaust.

24. The method of claim 23 further comprising:
arranging the control system with a first temperature sensor in the exhaust at the pollution control device;
enabling the first temperature sensor to sense a temperature in the exhaust at the pollution control device and generate a signal corresponding thereto; and
enabling the control system to: (v) receive the signal from the first temperature sensor; (vi) store a plurality of data structures in the memory of the controller, the plurality of data structures comprising a desired temperature level of the exhaust at the pollution control device; (vii) compare the first temperature sensor signal with the desired temperature level of the exhaust at the pollution control device; and (viii) generate a signal for controlling the drive of the drag chain conveyor system based upon a difference between the first temperature sensor signal and the desired temperature level of the exhaust at the pollution control device to control a rate of movement of the feedstock through at least one of the drying region of the first drag chain conveyor portion and the drying region of the second drag chain conveyor portion.

25. The method of claim 24 further comprising enabling the control system to generate a signal for controlling the drive of the drag chain conveyor system based upon the difference of the first temperature sensor signal with the desired temperature level in the exhaust at the pollution control device to control a rate of movement of the feedstock from the second drag chain conveyor portion into the at least one pyrolysis pot.

26. The method of claim 25 further comprising:
arranging the control system with a second temperature sensor in the exhaust at a heat exchanger downstream of the pollution control device;
enabling the second temperature sensor to sense a temperature in the exhaust at the heat exchanger and generate a signal corresponding thereto; and
enabling the control system to: (ix) receive the signal from the second temperature sensor; (x) store a plurality of data structures in the memory of the controller, the plurality of data structures comprising a desired temperature level of the exhaust at the heat exchanger; (xi) compare the second temperature sensor signal with the desired temperature level of the exhaust at the heat exchanger; and (xii) generate a signal for controlling the drive of the drag chain conveyor system based upon a difference between second temperature sensor signal and the desired temperature of the exhaust at the heat exchanger to control a rate of movement of the feedstock through at least one of the drying region of the first drag chain conveyor portion and the drying region of the second drag chain conveyor portion.

27. The method of claim 26 further comprising enabling the control system to generate a signal for controlling the drive of the drag chain conveyor system based upon the difference of the second temperature sensor signal with the desired temperature in the exhaust at the heat exchanger device to control a rate of movement of the feedstock from the second drag chain conveyor portion into the at least one pyrolysis pot.

28. The method of claim 27 further comprising:
arranging the control system with a third temperature sensor in the exhaust at an inducer fan downstream of the heat exchanger;
enabling the third temperature sensor to sense a temperature in the exhaust at the inducer fan and generate a signal corresponding thereto; and
enabling the control system to: (xiii) receive the signal from the third temperature sensor; (xiv) store a plurality of data structures in the memory of the controller, the plurality of data structures comprising a desired temperature level of the exhaust at the inducer fan; (xv) compare the third temperature sensor signal with the desired temperature level of the exhaust at the inducer fan; and (xvi) generate a signal for controlling the drive of the drag chain conveyor system based upon a difference between the third temperature sensor signal and the desired temperature of the exhaust at the inducer fan to control a rate of movement of the feedstock through at least one of the drying region of the first drag chain conveyor portion and the drying region of the second drag chain conveyor portion.

29. The method of claim 28 further comprising enabling the control system to generate a signal for controlling the drive of the drag chain conveyor system based upon the difference of the third temperature sensor signal with the desired temperature in the exhaust at the inducer to control a rate a rate of movement of the feedstock from the second drag chain conveyor portion into the at least one pyrolysis pot.

30. The method of claim 20 further comprising:
arranging an oxygen sensor in the exhaust;
enabling the oxygen sensor to sense a level of oxygen in the exhaust and generate a signal corresponding thereto; and
enabling the control system to: (v) receive the signal from the oxygen sensor; (vi) store a plurality of data structures in the memory of the controller, the plurality of data structures comprising a desired oxygen level of the exhaust at the inducer fan; (vii) compare the oxygen sensor signal with the desired oxygen level of the exhaust; and (viii) generate a signal for controlling the drive of the drag chain conveyor system based upon a difference between the oxygen sensor signal and the desired oxygen level of the exhaust.

31. The method of claim 20 further comprising:
arranging an oxygen sensor in the exhaust;
enabling the oxygen sensor to sense a level of oxygen in the exhaust and generate a signal corresponding thereto; and
enabling the control system to: (v) receive the signal from the oxygen sensor; (vi) store a plurality of data structures in the memory of the controller, the plurality of data structures comprising a desired oxygen level of the exhaust at the inducer fan; (vii) compare the oxygen sensor signal with the desired oxygen level of the exhaust at the inducer fan; and (viii) generate a signal for controlling the inducer fan based upon a difference between the oxygen sensor signal and the desired oxygen level of the exhaust at the inducer fan.

32. The method of claim 20 further comprising:
arranging an oxygen sensor in the exhaust;
enabling the oxygen sensor to sense a level of oxygen in the exhaust and generate a signal corresponding thereto; and
enabling the control system to (v) receive the signal from the oxygen sensor; (vi) store a plurality of data structures in the memory of the controller, the plurality of data structures comprising a desired oxygen level of the exhaust at the inducer fan; (vii) compare the oxygen sensor signal with the desired oxygen level of the exhaust at the inducer fan; and (viii) generate a signal for controlling the drive of the drag chain conveyor system based upon the difference between the oxygen sensor signal and the desired oxygen level of the exhaust at the inducer fan to control a rate of introduction of the feedstock into the at least one pyrolysis pot.

33. The method of claim 20 further comprising:
providing an auger to remove processed feedstock from at least one the pyrolysis pot; and
enabling the control system to generate signals for controlling a drive of the auger based at least in part upon the signal for controlling the drive of the drag chain conveyor system and the rate of movement of the feedstock through at least one of the drying region of the first drag chain conveyor portion and the drying region of the second conveyor portion of the drag chain conveyor system.

34. The method of claim 20 further comprising:
providing an auger to remove processed feedstock from at least one the pyrolysis pot; and
enabling the control system to generate signals for controlling a drive of the auger based at least in part upon the signal for controlling the drive of the drag chain conveyor system and a rate of introduction of the feedstock into the at least one pyrolysis pot.

35. The method of claim 20 wherein:
the step of moving the feedstock on the first drag chain conveyor portion comprises moving the feedstock on a first conveyor having an inlet and an outlet with the drying region extending between the inlet and outlet of the first conveyor;
the step of moving the feedstock on the second drag chain conveyor portion comprises moving the feedstock on a second conveyor having an inlet and an outlet with the drying region extending between the inlet and the outlet of the second conveyor; and further comprising:
configuring the outlet of the first conveyor to deposit feedstock at the inlet of the second conveyor; and
configuring the outlet of the second drag chain to deposit the feedstock in the at least one pyrolysis pot.

36. The method of claim 35 further comprising:
providing a first drive configured to control the first conveyor and a second drive configured to control the second drag chain conveyor; and
the step of generating the signal for controlling the drive of the drag chain conveyor system includes generating a signal for at least one of the first and second drives based upon the difference of the humidity sensor signal and the desired moisture level in the exhaust to control a rate of movement of the feedstock through at least one of the drying region of the first drag chain conveyor and the drying region of the second drag chain conveyor.

37. The method of claim 20 wherein step of introducing the feedstock into the biogenic refinery via the drag chain conveyor system includes providing feedstock comprising sanitary products with human waste.
